(19) United States
(12) Patent Application Publication
(10) Pub. No.: US 2017/0114189 A1
(43) Pub. Date: Apr. 27, 2017

(54) CELLULOSIC MICROSHEETS

(71) Applicant: TensTech Inc., Matthews, NC (US)

(72) Inventor: Thomas W. Theyson, Matthews, NC (US)

(21) Appl. No.: 15/334,494

(22) Filed: Oct. 26, 2016

Related U.S. Application Data
(60) Provisional application No. 62/246,824, filed on Oct. 27, 2015.

(51) Int. Cl. C08J 3/12

(52) U.S. Cl. CPC C08J 3/12; C08J 2301/02

(57) ABSTRACT

In one aspect, methods of producing cellulosic microsheets are described herein. In some embodiments, a method of producing cellulosic microsheets comprises milling or attritioning cellulose micro-fibrils for a time period sufficient to form the cellulosic microsheets. Additionally, in some cases, the cellulose micro-fibrils are derived from soy hulls. In another aspect, compositions comprising cellulosic microsheets are described herein.

### CROSS REFERENCE TO RELATED APPLICATIONS

This application claims priority pursuant to 35 U.S.C. §119(e) to U.S. Provisional Patent Application Ser. No. 62/246,824, filed on Oct. 27, 2015, which is hereby incorporated by reference in its entirety.

### FIELD

The present invention relates to cellulose material or cellulosic material and to methods and/or processes for the purification and generation of cellulosic material.

### BACKGROUND

Cellulose is the largest annually renewable natural material by volume, as it occurs in a wide variety of forms and can be isolated or extracted from a wide array of sources, including agricultural by-product materials. Additionally, cellulose fibers have been used for various applications. For example, cellulose fibers isolated from the flax plant have been used in the spinning of yarns for linen cloth. Similarly, cellulose fibers isolated from the cotton plant have been used in the spinning of yarns for cotton cloth. The shorter cellulose fibers isolated from wood may be used, inter alia, in the preparation of paper and paper board. More generally, the microstructure of cellulose or cellulosic material can significantly affect the properties and applications of the material.

A number of attempts have been made to provide processes for the isolation of cellulose from agricultural by-products. Unfortunately, some such processes have been limited by a number of disadvantages. For example, some previous methods have utilized a chlorine based oxidizing process to isolate cellulosic products. Such processes can result in extended process times, low yield, and/or the generation of chlorinated by-products which can be difficult to process as waste. Other methods have utilized a non-chlorine process with an extended heating period, resulting in long process times and relatively low yield. Thus, there is a need for improved methods for generating and/or isolating cellulosic material.

Moreover, there is also a need for additional non-naturally occurring forms of cellulose or cellulosic material, including forms having a new microstructure and/or morphology that may be particularly suitable for some applications.

### SUMMARY

In one aspect, methods of producing cellulosic material are described herein which, in some embodiments, can provide one or more advantages compared to other methods. For instance, in some cases, a method described herein can reduce or eliminate production of chlorine by-products during the generation and/or isolation of cellulosic material. In addition, in some instances, a method described herein can provide a reduced process time as compared to prior methods or processes. Such a reduced process time, in some cases, may include a reduced total cycle time and/or a reduced heating time. Further, a method described herein may also provide a high yield of cellulosic material and/or a high quality cellulosic material compared to some other methods. For example, in some embodiments, a method described herein can provide a yield of a desired cellulosic material of greater than about 30%, greater than about 40%, or greater than about 50%, based on the dry weight of a cellulose-containing starting material (such as legume hulls). In some cases, a method described herein can provide a cellulose yield between about 30% and about 60%, between about 40% and about 60%, between about 40% and about 55%, between about 45% and about 60%, or between about 45% and about 55%, based on the dry weight of the cellulose-containing starting material.

In some instances, a method of producing cellulosic material comprises dispersing legume hulls in water to form a first slurry. The method further comprises adding caustic material to the first slurry and heating the first slurry to at least partially solubilize one or more non-cellulose materials present in the first slurry. Additionally, in some embodiments, a method described herein further comprises physically separating cellulosic material from the first slurry to form a first product.

Moreover, in some cases, a first product isolated or generated by a method described herein can be further processed. For example, in some embodiments, a method can comprise dispersing the first product in water to form a second slurry and subjecting the second slurry to a high shear process. In certain embodiments, a method can further comprise physically separating cellulosic material from the second slurry to form a second product. The second product, in some cases, can comprise or include cellulose fibers or fibrils, such as “short” cellulose fibers or fibrils having a diameter between about 4 μm and about 7 μm and/or a length between about 40 μm and about 70 μm. Additionally, in certain embodiments, the second product can be milled or otherwise mechanically processed to form sheet-like cellulose structures, such as “microsheets” having a thickness of less than about 1.5 μm, a width of between about 25 μm and about 40 μm, and a length of between about 50 μm and about 70 μm. In some embodiments, a method described herein further comprises bleaching one or more cellulosic materials. Bleaching a cellulosic material can comprise heating the material and/or adding a bleaching agent to the material. In some cases, the bleaching agent does not comprise chlorine. Further, in certain instances, the bleaching agent oxidizes one or more residual non-cellulose materials present with the cellulosic material, such as one or more non-cellulose materials present in the first or second slurry described hereinabove. Further, in some cases, a method comprises reducing the pH of a slurry described herein to between about 6.5 and about 7.5.

In another aspect, compositions are described herein. In some embodiments, a composition can comprise sheet-like cellulose structures or cellulosic microsheets. The cellulosic microsheets, in some cases, have an average thickness of less than about 1.5 μm, an average width of between about 25 μm and about 40 μm, and/or an average length of between about 50 μm and about 70 μm. In some cases, a composition comprises at least about 80 weight percent (wt. %) sheet-like cellulose structures, based on the total weight of the composition or based on the total weight of all forms of cellulose included in the composition. Further, in some instances, the composition can form a semi-gel when dispersed in water at a concentration of at least about 3.0 wt. % of the composition. Thus, in some embodiments, a composition described herein may be used as a rheology modifier. Additionally, cellulosic microsheets described herein can be food grade materials. Further, in some embodiments, cellulosic microsheets described herein can form thin and stable films, such as films having a thickness of less than about 5 μm or less than about 3 μm. Moreover, such films, in some instances, can be used as a barrier coating in a wide range of applications. In addition, in some cases, cellulosic microsheets described herein can be coated with one or more coating materials. For example, in some embodiments, cellulosic microsheets described herein are coated with one or more hydrophobic and/or amphiphilic materials, such as one or more surfactants.

These and other embodiments are described in more detail in the detailed description which follows.

### BRIEF DESCRIPTION OF THE FIGURES

FIG. 1 illustrates a micrograph of cellulose micro-fibrils generated or isolated according to one embodiment of a method described herein.

FIGS. 2A and 2B illustrate micrographs of cellulose microsheets generated or isolated according to one embodiment of a method described herein.

### DETAILED DESCRIPTION

Embodiments described herein can be understood more readily by reference to the following detailed description, examples, and drawings. Elements, apparatus, and methods described herein, however, are not limited to the specific embodiments presented in the detailed description, examples, and drawings. It should be recognized that these embodiments are merely illustrative of the principles of the present invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” should generally be considered to include the end points 5 and 10.

In one aspect, methods of producing cellulosic material are described herein. “Cellulosic material,” for reference purposes herein, can comprise a material including cellulose as a primary or majority component. For example, in some cases, a cellulosic material comprises at least about 70 weight percent (wt. %), at least about 80 wt. %, at least about 90 wt. %, at least about 95 wt. %, or at least about 99 wt. % cellulose, based on the total weight of the cellulosic material. In some instances, a cellulosic material comprises about 70 to 100 wt. %, about 70 to 99 wt. %, about 70 to 95 wt. %, about 80 to 100 wt. %, about 85 to 99 wt. %, about 90 to 100 wt. %, or about 90 to 99 wt. % cellulose, based on the total weight of the cellulosic material. Further, a cellulosic material described herein can be in any physical form not inconsistent with the objectives of the present invention. For example, in some embodiments, a cellulosic material described herein comprises cellulose sheets or cellulose fibers such as short fiber cellulose.

In some instances, a method of producing cellulosic material comprises dispersing legume hulls, such as soy hulls, in water to form a first slurry. The method further comprises adding caustic material to the first slurry and/or heating the first slurry to at least partially solubilize one or more non-cellulose materials present in the first slurry. In some embodiments, heating the first slurry to at least partially solubilize one or more of the non-cellulose materials can comprise heating the first slurry to a temperature above 100° C., such as between about 105° C. and about 140° C. for about 5 minutes to about 240 minutes. Additionally, a method described herein, in some instances, comprises physically separating cellulose from the first slurry to form a first product, such as by centrifugation or filtration.

Additionally, in some cases, a first product isolated or generated by a method described herein can be further processed. For example, in some embodiments, a method can comprise dispersing the first product in water to form a second slurry and subjecting the second slurry to a high shear process such as homogenization. In certain embodiments, a method can further comprise physically separating cellulosic material from the second slurry to form a second product. The second product, in some cases, can comprise or include cellulose fibers or fibrils, such as “short” cellulose fibers or fibrils having a diameter between about 4 μm and about 7 μm and/or a length between about 40 μm and about 70 μm.

Further, in certain embodiments, the second product can be milled or otherwise mechanically or attrition processed to form sheet-like cellulose structures, such as microsheets having a thickness of about 1 μm, a width of between about 25 μm and about 40 μm, and a length of between about 50 μm and about 70 μm. In some embodiments, a method described herein further comprises bleaching one or more cellulosic materials. Bleaching a cellulosic material can comprise heating the material and/or adding a bleaching agent to the material. In some cases, the bleaching agent does not comprise chlorine. Further, in certain instances, the bleaching agent oxidizes one or more residual non-cellulose materials present with the cellulosic material, such as one or more non-cellulose materials present in the first or second slurry described hereinabove. Further, in some cases, a method comprises reducing the pH of a slurry described herein to between about 6.5 and about 7.5.

Turning now to specific steps of methods described herein, methods of producing cellulosic material comprise dispersing legume hulls in water to form a first slurry. Any legume hulls not inconsistent with the objectives of the present invention can be used. A “legume,” for reference purposes herein, is a plant in the family Fabaceae (or Leguminosae), or the fruit or seed of such a plant. In some embodiments, a legume hull used in a method herein can be an agricultural by-product with relatively low lignin content and a relatively high content of alpha cellulose. For example, in some cases, legume hulls used to form a first slurry can comprise or include soy bean hulls, pea hulls, corn hulls or bran, oat hulls, and/or combinations thereof. Moreover, in some embodiments, starting materials, such as legume hulls, do not comprise or include wood or the stalk portions of agricultural plants. Further, legume hulls can be dispersed in water in any form not inconsistent with the objectives of the present invention. In some cases, for instance, whole or unaltered legume hulls can be used. In some embodiments, the legume hulls are not milled or ground, or are only lightly milled or ground. In certain other embodiments, the legume hulls can be compacted or compressed, such as in the form of compacted pellets, prior to being dispersed in water. In some embodiments, legume hulls can be milled, such as by a hammer mill, prior to being dispersed in water. Treating legume hulls in such a manner, in some cases, can facilitate stirring of the slurry and/or increase the rate of reaction of the hulls with a caustic material.

Further, any ratio of legume hulls to water not inconsistent with the objectives of the present invention can be used to form a first slurry described herein. For example, a ratio of legume hulls to water can be selected from the values listed in Table I.

TABLE I
Ratio of Legume Hulls to Water

| Legume Hulls | Water |
|---|---|
| (parts by weight) | (parts by weight) |
| 15-50 | 100 |
| 20-45 | 100 |
| 25-40 | 100 |
| 15-40 | 100 |
| 20-50 | 100 |
| 20-40 | 100 |

Methods described herein also comprise adding caustic material to the first slurry. Any caustic material not inconsistent with the objectives of the present invention can be used. In some cases, a caustic material comprises, consists, or consists essentially of one or more of sodium hydroxide, potassium hydroxide, sodium carbonate, and/or an aqueous solution of one or more of the foregoing. Further, a caustic material described herein can be added to the first slurry in any manner and in any amount not inconsistent with the objectives of the present invention. In some embodiments, for instance, the caustic material is added to the first slurry quickly and/or all at once, rather than being added slowly, gradually, or at a plurality of time points during the manufacturing process. For example, in some cases, the caustic material is added to the first slurry over a time period of about 5 minutes or less, about 3 minutes or less, about 2 minutes or less, or about 1 minute or less. In some instances, the caustic material is added to the first slurry over a time period of less than about 30 seconds, less than about 20 seconds, less than about 10 seconds, or less than about 5 seconds. Moreover, in some embodiments, a larger total amount of caustic material is added in comparison to some prior methods, including in comparison to some prior methods in which caustic material may be added gradually or at a plurality of time points.

Additionally, methods described herein can comprise heating the first slurry. The first slurry can be heated to any temperature and for any time period not inconsistent with the objectives of the present invention. For example, in some embodiments, the first slurry is heated to at least about 105° C. In some cases, the first slurry is heated to a temperature between about 105° C. and about 140° C., between about 110° C. and about 130° C., or between about 115° C. and about 125° C. Further, in some instances, heating is carried out for a time period greater than about 5 minutes and/or for a time period less than about 4 hours, less than about 3 hours, less than about 2 hours, or less than about 1 hour. In some embodiments, heating is carried out for a time period between about 5 minutes and about 240 minutes, between about 10 minutes and about 120 minutes, between about 10 minutes and about 60 minutes, between about 10 minutes and about 30 minutes, between about 15 minutes and about 60 minutes, between about 15 minutes and about 30 minutes, or between about 30 minutes and about 90 minutes. In some cases, heating is carried out for a time period between about 60 minutes and 240 minutes, between about 30 minutes and about 120 minutes, or between about 5 minutes and about 90 minutes. Further, in some instances, the first slurry can be subsequently cooled to a temperature conducive to convenient handling.

Heating a first slurry and/or adding caustic material to a first slurry in a manner described herein, in some embodiments, can at least partially solubilize one or more non-cellulose materials present in the first slurry. For example, in some instances, heating and/or adding a caustic material to the first slurry can at least partially solubilize proteins, lignin, hemi-cellulose, and/or organic waxes present in the first slurry. In some cases, heating and/or adding a caustic material to a first slurry solubilizes up to about 99 wt. %, up to about 95 wt. %, up to about 90 wt. %, up to about 80 wt. %, up to about 75 wt. %, up to about 70 wt. %, up to about 60 wt. %, up to about 50 wt. %, or up to about 40 wt. % of non-cellulose materials present in the first slurry, based on the total weight of non-cellulose materials (where water is not considered to be a non-cellulose material). In some embodiments, heating and/or adding a caustic material to a first slurry solubilizes about 10 to 99 wt. %, about 10 to 95 wt. %, about 10 to 90 wt. %, about 20 to 90 wt. %, about 30 to 90 wt. %, about 40 to 90 wt. %, or about 50 to 80 wt. % of non-cellulose materials present in the first slurry.

Moreover, methods described herein, in some embodiments, also comprise physically separating or isolating cellulosic material from a slurry after completion of one or more steps described herein. Such a separating step can remove at least a portion of any liquids remaining in a slurry. Any method or apparatus for physical separation of cellulosic material from a slurry not inconsistent with the present invention can be used. For example, in some embodiments, a slurry can be centrifuged and the resulting supernatant can be removed. In certain other embodiments, the slurry can be filtered. Moreover, in some cases, physical separation comprises or includes a washing step to further remove impurities or to reduce caustic material concentration within the recovered portion, such as the solid portion, of the slurry. Other methods may also be used to provide a product comprising a washed and/or separated or isolated cellulosic material.

In some embodiments, a method described herein also comprises dispersing a first product described herein in water to form a second slurry. Any ratio of first product to water can be used not inconsistent with the objectives of the present invention. For example, a ratio of first product to water can be selected from Table II.

TABLE II
Ratio of First Product to Water

| First Product | Water |
|---|---|
| (parts by weight) | (parts by weight) |
| 10-30 | 100 |
| 15-30 | 100 |
| 10-25 | 100 |
| 15-25 | 100 |
| 12-24 | 100 |

In addition, in some cases, a method described herein can further comprise subjecting a second slurry described herein to a high shear process. Not intending to be bound by theory, it is believed that subjecting the slurry to a high shear process can separate cellulosic material present in the slurry into individual and/or separated fibers. Any high shear process not inconsistent with the objectives of the present invention can be used. For example, in some cases, one or more high shear mixers can be used. Subjecting a second slurry to a high shear process may also comprise or include homogenization, high shear in-line mixing, and/or colloid mill processing of the slurry. Moreover, embodiments utilizing homogenization can operate at any pressure not inconsistent with the objectives of the present invention. In some embodiments, for instance, homogenization pressure can be greater than about 500 pounds per square inch (psi), greater than about 1000 psi, or greater than about 1500 psi. In some cases, homogenization pressure is greater than about 2000 psi, greater than about 2500 psi, or greater than or equal to about 3000 psi.

A method described herein, in some embodiments, also comprises or includes bleaching cellulosic material present at one or more stages of the method. Bleaching can be performed at any step or at any stage not inconsistent with the objectives of the present invention. For example, bleaching cellulosic material can be performed on a first slurry, a first product, a second slurry, and/or a second product described herein. Further, bleaching can comprise any steps or processes not inconsistent with the objectives of the present invention. In some embodiments, for instance, bleaching cellulosic material comprises heating the cellulosic material. In such embodiments, the cellulosic material can be heated to any temperature not inconsistent with the objectives of the present invention. For example, in some cases, the cellulosic material is heated to at least about 70° C., such as between about 70° C. and about 100° C., between about 80° C. and about 100° C., or between about 90° C. and about 100° C. Further, in some cases, the cellulosic material can be heated to a temperature less than about 100° C., such as a temperature between about 70° C. and about 98° C., between about 80° C. and about 98° C., or between about 90° C. and about 98° C. Moreover, the cellulosic material can be heated for any time period not inconsistent with the objectives of the present invention. In some cases, cellulosic material is heated for a time period greater than or equal to about 10 minutes, greater than or equal to about 20 minutes, or greater than or equal to about 30 minutes. In some instances, cellulosic material is heated for a time period of about 10 to 60 minutes, about 10 to 40 minutes, about 10 to 30 minutes, or about 20 to 30 minutes. In addition, in some embodiments wherein bleaching is carried out by heating, the temperature of the cellulosic material may be reduced prior to subsequent processing, such as to a temperature between about 40° C. and about 60° C., in order to facilitate safe and convenient handling of the bleached first slurry, first product, second slurry, and/or second product. Bleaching may also be carried out by adding a bleaching agent to the cellulosic material. Such a bleaching agent can be added to the cellulosic material before, during, or after heating of the cellulosic material. A bleaching agent may also be added to the cellulosic material without heating the cellulosic material in the bleaching stage. Further, any bleaching agent not inconsistent with the objectives of the present invention can be used. In some embodiments, the bleaching agent is a non-chlorine bleaching agent and/or does not comprise or contain chlorine. For example, in some embodiments, a bleaching agent can comprise, consist, or consist essentially of a peroxide bleach such as hydrogen peroxide or a hydrogen peroxide solution (e.g. 30% hydrogen peroxide solution), sodium percarbonate, and/or sodium perborate. In some cases, a bleaching agent can comprise, consist, or consist essentially of one or more of peracetic acid, ozone, benzoyl peroxide, and/or sodium dithionite. Moreover, in some embodiments, a bleaching agent is operable to oxidize one or more residual non-cellulose materials present with the cellulosic material, such as one or more non-cellulose materials present in the first slurry, first product, second slurry, and/or second product.

Further, in some embodiments, the pH of one or more of the first slurry, first product, second slurry, and/or second product can be neutralized, adjusted, and/or reduced as part of a method described herein. Such neutralization, pH adjustment, and/or pH reduction can be carried out in any manner not inconsistent with the objectives of the present invention. For example, an effective amount of an aqueous acid can be added to the first slurry, first product, second slurry, and/or second product to reduce or adjust the pH to a substantially neutral pH range. For reference purposes herein, a “substantially neutral pH range” can comprise or include any pH in the range between about 6.5 and about 7.5, such as a pH between about 6.8 and 7.2. In addition, any acid not inconsistent with the objectives of the present invention may be used. For example, in some embodiments, an acid used to neutralize one or more of the first slurry, first product, second slurry, and/or second product can be a mineral acid. Non-limiting examples of mineral acids that can be used in certain embodiments comprise or include hydrochloric acid (HCl), nitric acid (HNO₃), phosphoric acid (H₃PO₄), sulfuric acid (H₂SO₄), boric acid (H₃BO₄), hydrofluoric acid (HF), hydrobromic acid (HBr), and/or perchloric acid (HClO₄). In other cases, an organic acid can be used to neutralize or reduce the pH of a substance described herein. Non-limiting examples of organic acids that can be used in certain embodiments described herein include formic acid, acetic acid, propionic acid, butyric acid, valeric acid, caproic acid, oxalic acid, lactic acid, malic acid, citric acid, benzoic acid and/or carbonic acid.

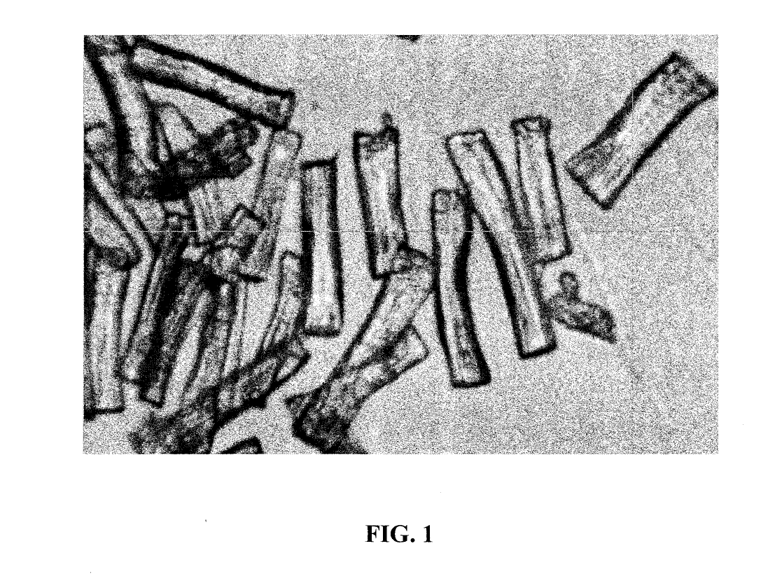

Cellulosic material generated or provided by methods described herein can have any dimensions or exhibit any properties not inconsistent with the objectives of the present invention. For example, in some cases, the second product comprises or includes “short” cellulose fibers or fibrils having a diameter between about 1 μm and about 15 μm, such as an average diameter between about 2 μm and about 12 μm, between about 3 μm and about 10 μm, or between about 4 μm and about 7 μm. Further, in some embodiments, short fibers or fibrils can have an average length between about 20 μm and about 100 μm, such as an average length between about 25 μm and about 90 μm, between about 30 μm and about 80 μm, or between about 40 μm and about 70 μm. FIG. 1 illustrates one embodiment of short fibers or fibrils demonstrating dimensions and/or aspect ratios consistent with the foregoing. Additionally, in some cases, short fibers or fibrils described herein can form a semi-gel when dispersed in water. For example, in some instances, short fibers or fibrils generated or provided by methods described herein can form a semi-gel when dispersed in water at a ratio of between about 4 wt. % and about 8 wt. %, between about 5 wt. % and about 7 wt. %, or between about 6 wt. % and about 7 wt. %, such as between about 6.5 wt. % and about 6.8 wt. %, based on the total weight of the water and fibrils. Moreover, a semi-gel described herein, in some cases, can be thixotropic. In addition, a semi-gel such as an aqueous semi-gel described herein can exhibit a viscosity that is lower than the viscosity of an otherwise similar gel formed from the cellulosic material.

In some embodiments, a method described herein can further comprise milling or otherwise attritioning or attrition processing cellulosic material to reduce the fiber or particle size of the cellulosic material, including the cellulosic material of a first and/or second product described herein. Moreover, in some instances, milling can alter the physical form of cellulosic material, such as from a fibril structure to a sheet structure. Any milling or attrition process not inconsistent with the objectives of the present invention can be used. For example, in some embodiments, milling can be performed by one or more of a ball mill, rod mill, autogenous mill, semi-autogenous grinding (SAG) mill, pebble mill, high pressure grinding rolls, buhrstone mill, vertical shaft impactor mill, tower mill, and/or a hammer mill.

Further, in some cases, the time of the milling or attritioning process is selected to be sufficiently long to substantially flatten the cellulose fibers to form microsheets but not long enough to convert the microsheets into cellulosic particles. A suitable time in a specific instance can depend on the type of mill or milling or attrition process used. Additionally, in some embodiments, milling is carried out in the presence of water. In other cases, milling is carried out in the presence of a solvent. Any solvent not inconsistent with the objectives of the present invention may be used. Solvents may include, but are not necessarily limited to, organic solvents or chlorinated solvents such as hydrocarbons, alcohols, glycols, ethers, esters, furans, benzene, toluene, carbon tetrachloride, dimethylformamide, and xylene. Milling may also be carried out in the presence of a mixture of water and a solvent.

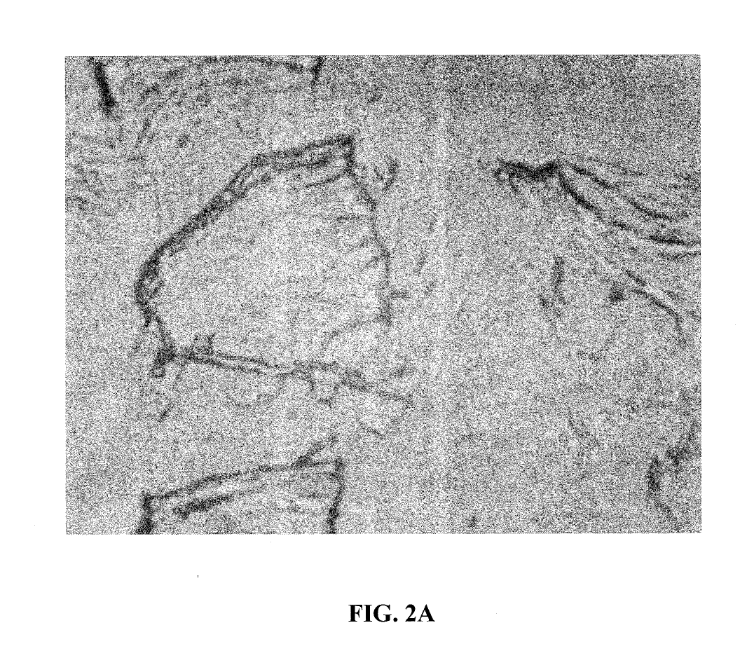

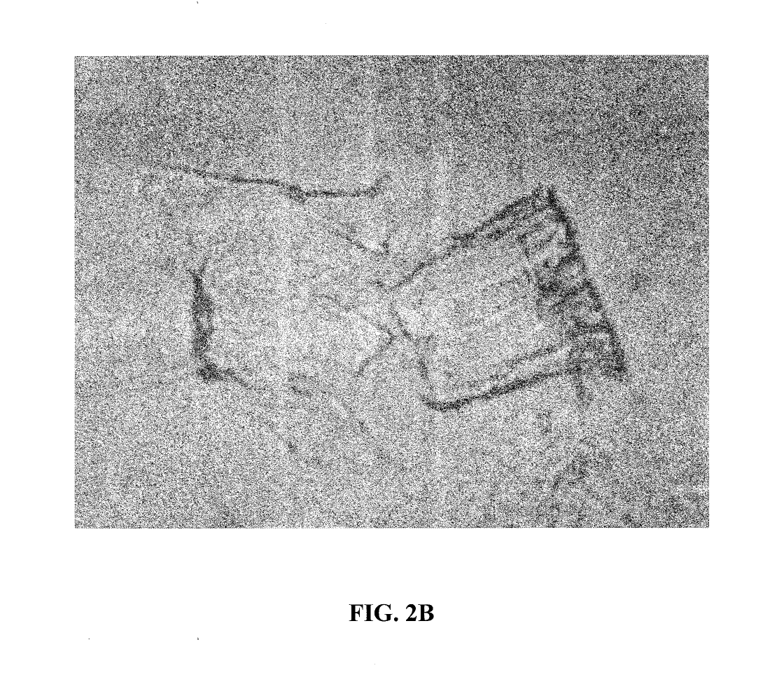

Additionally, milled or ground cellulose fibers or particles can have any dimensions or aspect ratios not inconsistent with the objectives of the present invention. For example, in some embodiments, grinding or milling can generate or provide a composition comprising cellulose structures in the form of “microsheets” having a form factor similar to the embodiments illustrated in FIGS. 2A and 2B. Microsheets can have any properties not inconsistent with the objectives of the present invention. For example, in some embodiments, microsheets have an average thickness of less than about 3 μm, such as less than about 2 μm, or less than about 1.5 μm, such as about 1 μm. In some instances, microsheets have an average thickness between about 0.5 μm and about 2 μm. In certain cases, microsheets can have an average width greater than about 15 μm, such as between about 20 μm and about 60 μm, between about 25 μm and about 50 μm, or between about 25 μm and about 40 μm. Additionally, in some embodiments, microsheets have an average length greater than about 30 μm, such as between about 30 μm and about 100 μm, between about 40 μm and about 80 μm, or between about 50 μm and about 70 μm. Further, microsheets can, in some embodiments, form a semi-gel when dispersed in water at a ratio of between about 1 wt. % and about 5 wt. %, between about 2 wt. % and about 4 wt. %, between about 3 wt. % and about 4 wt. %, or between about 2.5 wt. % and about 3.5 wt. %, such as about 3.0 wt. %, based on the total weight of the water and the microsheets. Further, in some embodiments, cellulose-containing compositions are described in which the composition comprises greater than about 70 wt. % sheet-like or microsheet cellulose, such as between about 70 wt. % and about 100 wt. %, between about 75 wt. % and about 100 wt. %, between about 80 wt. % and about 95 wt. %, or between about 80 wt. % and about 85 wt. %, based on the total weight of the composition or based on the total weight of the cellulosic material present in the composition.

Cellulosic microsheets described herein can further exhibit a highly hydrophilic surface. Moreover, the small size of the sheet structure and the high surface area of the sheet structure can permit use of the microsheets in additional applications. For instance, the microsheets can display a very high affinity for cellulosic surfaces and can disperse in water to form superstructures or agglomerates based on sheet-surface-to-sheet-surface interactions of the microsheets.

It is further to be understood that individual steps or stages of a method described herein can be carried out in any manner or in any order not inconsistent with the objectives of the present invention. For example, in some embodiments, a method comprises dispersing legume hulls in water to form a first slurry, adding caustic material to the first slurry, heating the first slurry to at least partially solubilize one or more residual non-cellulose materials within the first slurry, and physically separating cellulosic material from the first slurry to form a first product. In certain other embodiments, a method described herein can comprise dispersing a first product in water to form a second slurry, subjecting the second slurry to a high shear process, bleaching the second slurry, reducing the pH of the second slurry to neutralize the second slurry, and physically separating cellulosic material from the second slurry to form a second product. Moreover, in some cases, addition of caustic material in a step of a method described herein can be performed without heating to solubilize one or more residual non-cellulose materials. Similarly, a bleaching step can be carried out without neutralization. Other combinations or sub-combinations of the foregoing steps or stages can also be used. Further, in some embodiments, additional processing steps can be included in a method described herein. For example, in some instances, agitation of a slurry or product can occur during dispersal of the legume hulls in water, during addition of caustic material, while heating the first slurry to solubilize one or more residual non-cellulose materials, while dispersing the first product to form a second slurry, while subjecting a slurry to a high shear process, during bleaching of the cellulose, and/or while adjusting or reducing the pH of the cellulose.

One embodiment of a method described herein is further illustrated in the following non-limiting example.

### Example 1

### Method of Producing Short Fiber Cellulose

43.5 kg of water was charged to a 75 liter stainless steel oil-heated pressure reactor. The water was then heated to 60° C. and agitated while 9.5 kg of pelletized soy hulls was added to the reactor to form a first slurry. 3.0 kg of 50% sodium hydroxide was added to the first slurry. The reactor was sealed and heated to a temperature of 120° C. to at least partially solubilize one or more of the non-cellulose materials present in the first slurry, and the first slurry was maintained at this temperature for 40 minutes. The first slurry was then cooled to 60° C. and discharged into a container. Next, the first slurry was centrifuged and washed to physically separate cellulose from the first slurry to form a first product. The supernatant liquid and wash water were discarded. The isolated first product at this stage was about 15-18 kg in weight and included about 30-33% solids.

Next, 60.0 kg of water was charged into the reactor and the isolated first product was re-dispersed in the water to form a second slurry. The second slurry was heated to 40° C. and subjected to a high shear process. Specifically, the second slurry was homogenized for two passes at a pressure of 3000 psi. The second slurry was then heated to 95 to 98° C. for one hour and the pH was reduced to 6.8 to 7.2 with acetic acid in order to neutralize any remaining caustic material. After cooling the second slurry to 60° C., the product was discharged from the reactor into a vessel. The second slurry was then centrifuged and washed with water to isolate a second product. The supernatant liquid and wash water were discarded. The isolated second product at this stage was about 17-19 kg in weight and included about 25-28% solids. The second product was oven dried and subjected to a light milling process using a hammer mill to separate any fibers that clumped together during the drying process. The dry yield of cellulose fibers was about 51-53%, based on the dry weight of soy hulls used to form the first slurry.

The dried cellulose is illustrated in FIG. 1 and exhibited the properties provided in Table III. In Table III, the moisture content is the % moisture (water) by weight, based on the total weight of the composition. The lignin content is the % lignin by weight, based on the total weight of the composition, where the amount of lignin in the composition is based on the Kappa number when measured in accordance with ISO 302:2004. Similarly, the ash content and the protein content in Table III are also based on the total weight of the composition.

TABLE III
Dried Cellulose Properties

| | |
|---|---|
| Moisture (wt. %) | <1.0 |
| Lignin wt. %) | 0.5 |
| Ash (wt. %) | 1.3 |
| Protein (wt. %) | 0.4 |
| pH | 6.9 |
| Color | Slight off white |
| Flavor | Neutral or Near Neutral |
| Particle size | Fibers: 40-70 μm long, |
| | 4-7 μm in diameter |
| Free Water | 450 |
| Absorption (%) | |
| Alpha cellulose | 83.9 |
| content (%) | |
| (x-ray analysis) | |
| Thermal Stability | High |

### Example 2

### Preparation and Modification of Soy Hull Based Cellulosic Microsheets

Cellulose micro-fibrils, isolated from soy hulls as described in Example 1 or obtained from commercial sources (such as SunOpta Inc. or Fibrid Inc.) are converted into cellulose microsheets by the following process.

Cellulose microfibers, isolated from soy hulls, in the crude wet cake form or bleached wet cake form or a dried solid form, are dispersed in water and the dispersion concentration is adjusted to ˜3% solids. The dispersion is put into a mechanical attrition mill or related device that is designed to provide particle size reduction. This attrition device could be a ball mill, a bead mill, a sand mill or any other type of mechanical mill where a media is used to reduce the particle size of a dispersed solid. The mill is run and during that time, the dispersion is monitored using rheology (the viscosity in increasing) and microscopic observation to determine when the conversion from micro-fibrils to micro sheets is essentially complete. Milling time is dependent on both the mill configuration, the size of the milling media and other mill variables familiar to those skilled in the art. At the end of the milling process, the bulk of the micro-fibrils have been converted to microsheets (based on microscopic observation) and the viscosity has stabilized.

The cellulosic microsheets obtained from the above process can be treated or surface modified to provide a range of modified properties. These could include hydrophobic surface modification, reactive surface modification, anionic or cationic surface modification and the like. The chemistries and processes to generate such modified cellulose surfaces are well known to those skilled in the art of modifying cellulosic materials for other applications. Cellulose microsheets may also be incorporated into a number of foods, products or materials to augment or enhance their performance or functional properties.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. A composition comprising cellulosic microsheets.

2. The composition of claim 1, wherein the cellulosic microsheets have a thickness of less than about 1.5 μm, a width of between about 25 μm and about 40 μm, and a length of between about 50 μm and about 70 μm.

3. The composition of claim 1, wherein the composition comprises at least about 80 weight percent cellulosic microsheets, based on the total weight of the composition.

4. A method of making cellulosic microsheets comprising:
milling or attritioning cellulose micro-fibrils for a time period sufficient to form the cellulosic microsheets.

5. The method of claim 4, wherein the cellulose micro-fibrils are isolated from soybean hulls.

6. The method of claim 4 further comprising modifying a surface of the cellulosic microsheets.

7. The method of claim 6, wherein the surface of the cellulosic microsheets is modified to be hydrophobic.
